(19) United States
(12) Patent Application Publication
(10) Pub. No.: US 2004/0065452 A1
(43) Pub. Date: Apr. 8, 2004

(54) Weed digger apparatus

(76) Inventor: DeDe T. Baker, Oklahoma City, OK (US)

Correspondence Address: S. Michael Bender, P.O. Box 530399, St. Petersburg, FL, 33747, US

(21) Appl. No.: 10/461,572

(22) Filed: Jun. 14, 2003

Related U.S. Application Data
(60) Provisional application No. 60/415,901, filed on Oct. 4, 2002.

(51) Int. Cl. A01B 1/00

(52) U.S. Cl. 172/378

(57) ABSTRACT

A weed digger apparatus includes a fork portion and a polygonal cross section shaft portion connected to the fork portion. A handle portion is connected to the shaft portion. A leverage block is supported on the shaft portion and extends below the shaft portion. Sliding block-to-shaft connection means are provided for connecting the leverage block to the shaft portion. The leverage block provides a fulcrum, and the fulcrum provides a first lever arm and a second lever arm which permit a one-hand operation for pulling weeds up from the ground. Preferably, the sliding block-to-shaft connection means include a polygonal cross section shaft reception groove in the leverage block which is complementary to the polygonal cross section shaft portion. The polygonal cross sections prevent the shaft portion from rotating within the shaft reception groove as the weed is being pulled up from the ground. A set screw may optionally be provided to selectably affix the position of the leverage block relative to the shaft portion.

### CROSS-REFERENCE TO RELATED APPLICATION

This application claims priority based upon my copending Provisional Application Serial No. 60/415,901; filed Oct. 4, 2002.

### BACKGROUND OF THE INVENTION

1. Field of the Invention

The present invention relates generally to manually operated gardening implements and, more particularly, to manually operated gardening implements which employ leverage for removing weeds from the ground.

2. Description of the Prior Art

In gardening, it is often desirable to remove weeds from the garden. Often, to do so, weeds are dug up by manually operated implements. In this respect, throughout the years, a number of innovations have been developed relating to manually operated weed removal implements, and the following U.S. patents are representative of some of those innovations: U.S. Pat. Nos. 202,444, 1,797,101, 2,373,898, 2,716,538, and 3,767,251. More specifically, U.S. Pat. No. 202,444 discloses a manually operated implement which includes a handle portion, a shaft portion, and a blade portion. No added fulcrum is provided to increase leverage or to assist in rotation of a weed acted upon by the implement. In this respect, it would be desirable if a manually operated implement were provided that included a fulcrum to provide for increased leverage and to assist in rotation of a weed being removed from the ground by the implement.

U.S. Pat. No. 1,797,101 discloses a manually operated implement which includes two tools, a fork and a hoe. Both the fork and the hoe are oriented perpendicular to the longitudinal axis of the handle of the implement. It may be difficult to apply a lot of ground penetrating force to the fork when the fork is perpendicular to the handle. Such a ground-penetrating force would generally be applied as a swinging action of the fork by the handle. With a swinging action, it is difficult to achieve accuracy in the application of the fork to the weed. Instead, to permit greater penetrability of the fork into the ground, and to provide accuracy in applying the fork to the weed, it would be desirable if a manually operated implement has a ground-penetrating fork portion and a handle portion that are arrayed along a common longitudinal axis. With such an arrangement, a significant amount of ground-penetrating force can be applied accurately to the ground near a selected weed. With such an arrangement, so swinging action is employed.

U.S. Pat. No. 2,373,898 discloses a manually operated implement which includes a fork oriented approximately perpendicular to the axis of the handle. A fixed fulcrum is employed to provide a fixed lever arm and a fixed ratio of leverage. Because different people have different strength and because different weeds require different amounts of force for removal from the ground, it would be desirable if a manually operated implement were provided which includes variable leverage. That is, it would be desirable if a manually operated implement were provided with a movable fulcrum.

U.S. Pat. No. 2,716,538 discloses a manually operated implement that includes a fixed fulcrum and a non-forked, shovel-like blade. A forked end has an advantage for removing weeds. The tines of the fork are position around the weed to straddle the weed. The weed becomes wedged between the tines of the fork. The wedging of the weed between the tines of the fork facilitates the removal of the weed from the ground. Therefore, it would be desirable if a manually operated implement includes a fork end that enables wedging of a weed between the tines of the fork.

U.S. Pat. No. 3,767,251 discloses a hinged fork located at the end of a manually operated implement. A direction-reversing mechanism is provided. As the operator pushes downward on the handle, the hinged fork is lifted upward. To avoid the complexities inherent in a device which includes such a hinged fork and direction-reversing mechanism, it would be desirable if a manually operated implement were provided that does not include a hinged fork and a direction-reversing mechanism.

Thus, while the foregoing body of prior art indicates it to be well known to use a manually operated implement for removing weeds from the ground, the prior art described above does not teach or suggest a weed digger apparatus which has the following combination of desirable features: (1) provides a manually operated implement that includes a fulcrum to provide for increased leverage and to assist in rotation of a weed being removed from the ground by the implement; (2) provides a manually operated implement has a ground-penetrating fork portion and a handle portion that are arrayed along a common longitudinal axis; (3) provides a manually operated implement having variable leverage provided by a movable fulcrum; (4) provides optional means for temporarily affixing the position of the movable fulcrum; (5) includes a fork end that enables wedging of a weed between the tines of the fork; and (6) does not include a hinged fork and does not include a direction-reversing mechanism. The foregoing desired characteristics are provided by the unique weed digger apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a weed digger apparatus which includes a fork portion and a shaft portion connected to the fork portion. A handle portion is connected to the shaft portion. A leverage block is supported on the shaft portion and extends below the shaft portion. Sliding block-to-shaft connection means are provided for connecting the leverage block to the shaft portion. The leverage block provides a fulcrum, and the fulcrum provides a first lever arm and a second lever arm which permit a one-hand operation for pulling weeds up from the ground.

Preferably, the fork portion, the shaft portion, and the handle portion are arrayed along a common longitudinal axis.

Preferably, the sliding block-to-shaft connection means include a shaft reception groove in the leverage block. The shaft reception groove includes a groove width which is greater than a shaft width, and the shaft reception groove includes a groove height which is greater than a shaft height. A retention plate covers the shaft reception groove, and plate-to-block connector means are provided for connecting the retention plate to the leverage block. The plate-to-block connector means include plate retention fasteners.

Preferably, the fork portion includes a pair of converging tines or a sharpened notched distal end edge. Preferably, the shaft portion includes a polygonal shaft cross section, and the leverage block includes a shaft reception groove which includes a complementary polygonal groove cross section. The polygonal shaft cross section and the complementary polygonal groove cross section can be square cross sections. The square cross sections prevent the shaft portion from rotating within the shaft reception groove as the weed is being pulled up from the ground.

Preferably, optional means are provided to selectably affixing the position of the leverage block relative to the shaft portion.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved weed digger apparatus which has all of the advantages of the prior art and none of the disadvantages.

It is another object of the present invention to provide a new and improved weed digger apparatus which may be easily and efficiently manufactured and marketed.

It is a further object of the present invention to provide a new and improved weed digger apparatus which is of durable and reliable construction.

An even further object of the present invention is to provide a new and improved weed digger apparatus which is susceptible of a low cost of manufacture with regard to both materials and labor, and which accordingly is then susceptible of low prices of sale to the consuming public, thereby making such weed digger apparatus available to the buying public.

Still yet a further object of the present invention is to provide a new and improved weed digger apparatus which provides a manually operated implement that includes a fulcrum to provide for increased leverage and to assist in rotation of a weed being removed from the ground by the implement.

Still another object of the present invention is to provide a new and improved weed digger apparatus that provides a manually operated implement which has a ground-penetrating fork or distal end portion and a handle portion that are arrayed along a common longitudinal axis.

Yet another object of the present invention is to provide a new and improved weed digger apparatus which provides a manually operated implement having variable leverage provided by a movable fulcrum.

Still another object of the invention is to provide optional locking means for temporarily affixing the position of the movable fulcrum.

Even another object of the present invention is to provide a new and improved weed digger apparatus that includes a fork end that enables wedging of a weed between the tines of the fork.

Still a further object of the present invention is to provide a new and improved weed digger apparatus which does not include a hinged fork and does not include a direction-reversing mechanism.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a perspective view showing a preferred embodiment of the weed digger apparatus of the invention, in position for digging a weed out of the ground.

FIG. 2 is an enlarged side view of the embodiment of the weed digger apparatus shown in FIG. 1.

FIG. 3 is a top view of the embodiment of the weed digger apparatus of FIG. 2 taken along line 3-3 thereof.

FIG. 4 is an enlarged cross-sectional view of the embodiment of the invention shown in FIG. 3 taken along line 4-4 thereof.

FIG. 5 is an exploded perspective view of the embodiment of the invention shown in FIGS. 1-4.

FIG. 6 is an enlarged side view of an alternatively preferred embodiment of the weed digger apparatus according to the present invention further including an adjustable locking means adapted to be employed to manually and temporarily affix the leverage block relative to and along the shaft of the apparatus.

FIG. 7 is an enlarged view taken along line 7-7 of FIG. 6 showing the details of the locking means employed to manually and temporarily affix the leverage block relative to and along the shaft of the apparatus.

FIG. 8 shows a plan view of yet another alternatively preferred embodiment of the present invention where the distal end of the apparatus terminates in a sharpened notched edge.

FIG. 9 shows a fragmentary enlarged plan view of the distal edge portion indicated by circle 9 in FIG. 8.

### DESCRIPTION OF THE PREFERRED EMBODIMENT

With reference to the drawings, a new and improved weed digger apparatus embodying the principles and concepts of the present invention will be described.

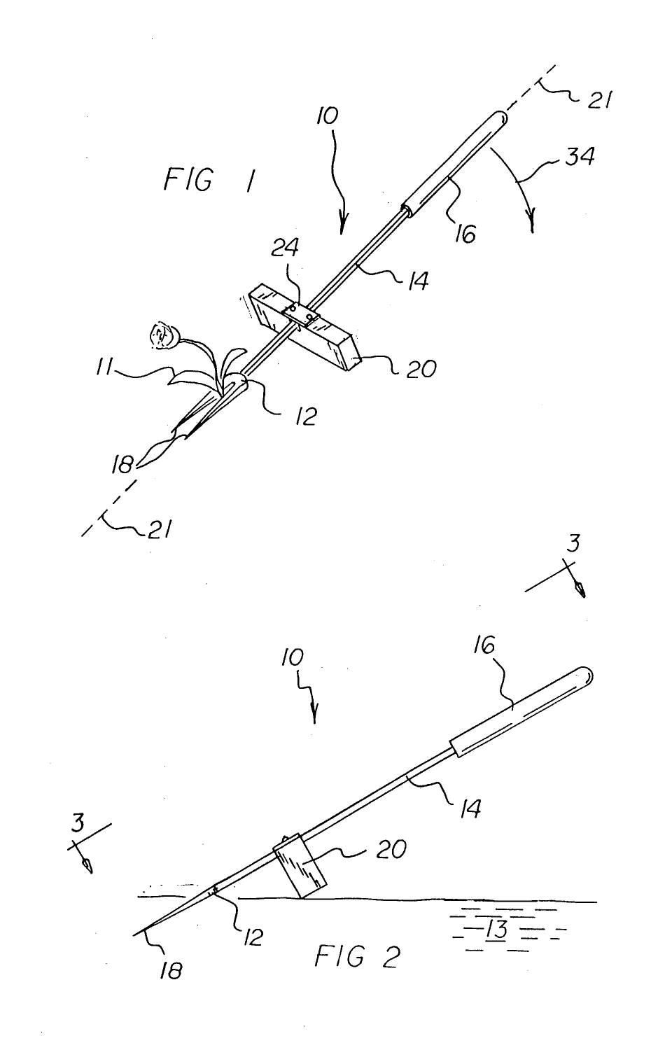

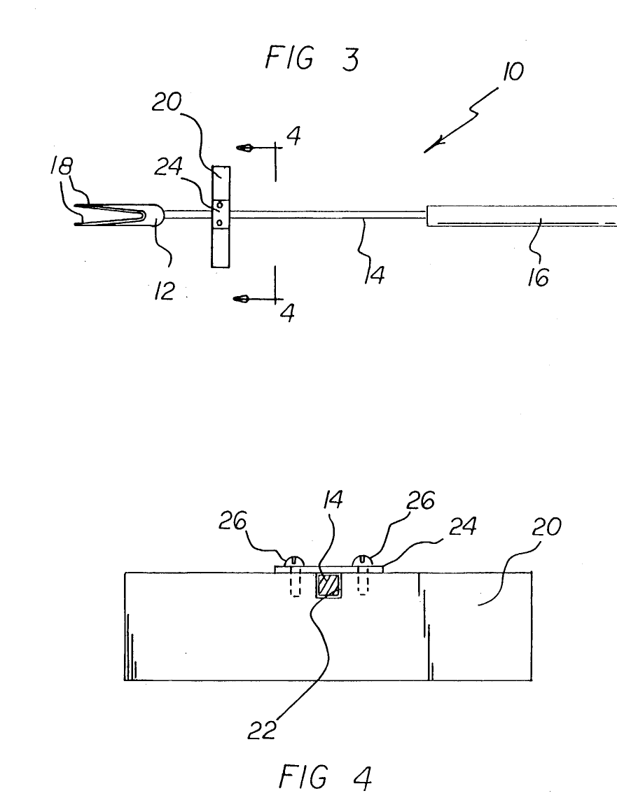

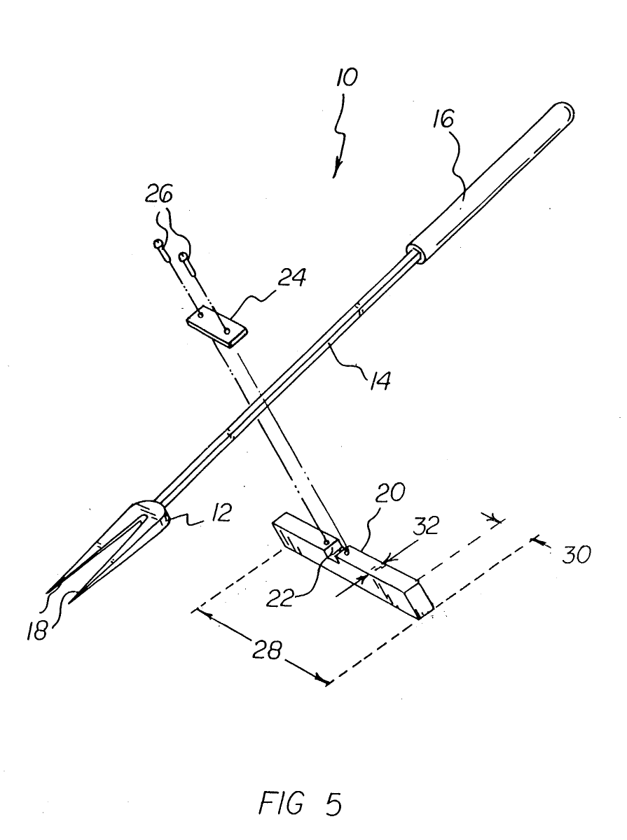

Turning to FIGS. 1-5, there is shown a preferred embodiment of the weed digger apparatus of the invention generally designated by reference numeral 10. In the preferred embodiment, the weed digger apparatus 10 includes a fork portion 12 and a shaft portion 14 connected to the fork portion 12. A handle portion 16 is connected to the shaft portion 14. A leverage block or other member 20 is supported on the shaft portion 14 and extends below the shaft portion 14. Sliding block-to-shaft connection means are provided for connecting the leverage block 20 to the shaft portion 14 substantially in the position shown in FIGS. 1-4 of the drawings.

Preferably, the fork portion 12, the shaft portion 14, and the handle portion 16 are arrayed along a common longitudinal axis 21.

Preferably, the sliding block-to-shaft connection means includes a shaft reception groove 22 in the leverage block or member 20. The shaft reception groove 22 includes a groove width which is greater than a shaft width, and the shaft reception groove 22 includes a groove height which is greater than a shaft height. A retention plate 24 covers the shaft reception groove 22, and plate-to-block connector means are provided for connecting the retention plate 24 to the leverage block 20. The plate-to-block connector means includes plate retention fasteners 26.

Preferably, the fork portion 12 includes a pair of converging tines 18. Preferably, the shaft portion 14 includes a polygonal shaft cross section, and the leverage block 20 includes a shaft reception groove 22 which includes a complementary polygonal groove cross section. The polygonal shaft cross section and the complementary polygonal groove cross section can be square cross sections.

The leverage block 20 includes a leverage block length 28, a leverage block height 30, and a leverage block thickness 32. Although the dimensions of the weed digger apparatus 10 of the invention can be any desirable dimensions, the following dimensions are suitable. The leverage block length 28 can be 6 inches long. The leverage block height 30 can be 1.5 inches wide. The leverage block thickness 32 can be 0.75 inches thick. The handle portion 16 can 5 inches long. The fork portion 12 can be 3.25 inches long. The overall length of the weed digger apparatus 10 can be 13 inches.

To assemble the weed digger apparatus 10, the plate retention fasteners 26 are removed from the leverage block 20, and the retention plate 24 is lifted off of the leverage block 20. A portion of the shaft portion 14 is placed in the complementary shaft reception groove 22. Then, the retention plate 24 is placed over the shaft portion 14, and the plate retention fasteners 26 are reattached to the leverage block 20.

To use the weed digger apparatus 10, a weed 11 is located, such as shown in FIG. 1. The fork portion 12 is shoved into the ground 13 near the weed 11 so that the converging tines 18 straddle the weed 11. The fork portion 12 is pushed towards the weed 11 so that the roots of the weed 11 rest against the top portion of the fork portion 12, which is where the two converging tines 18 meet the fork portion 12. Then, the leverage block 20 is moved along the shaft portion 14 so that the bottom of the leverage block 20 rests against the ground 13. Then, the user pushes down on the handle portion 16 so that the handle portion 16 and the portion of the shaft portion 14 which is on the handle side of the leverage block 20 move downward, as shown by directional arrow 34. The leverage block 20 forms a fulcrum for a first lever arm which moves downward and for a second lever arm which moves upward, pulling the weed 11 up by its roots. The second lever arm extends from the leverage block 20 to the fork portion 12 along the shaft portion 14.

The leverage block length 28 and the leverage block thickness 32 are selected so that when the handle portion 16 is pushed downward, a relatively large surface area of the bottom of the leverage block 20 will prevent or impede the leverage block 20 from sinking into the ground 13 when the weed 11 is pulled up from the ground 13.

The leverage block 20 can be slid or moved along the shaft portion 14 to provide a desired fulcrum position for a desired first lever arm and second lever arm. As is well known, the relative lengths of a first lever arm and a second lever arm determine the mechanical advantage of a lever. In this respect, the relative lengths of the first lever arm and the second lever arm determine the mechanical advantage provided by the weed digger apparatus 10 of the invention. The fulcrum and the leverage provided by the weed digger apparatus 10 of the invention permits weeds to be dug up from the ground 13 using a one-hand operation. The square cross section of the shaft portion 14 and the shaft reception groove 22 prevent the shaft portion 14 from rotating around in the shaft reception groove 22.

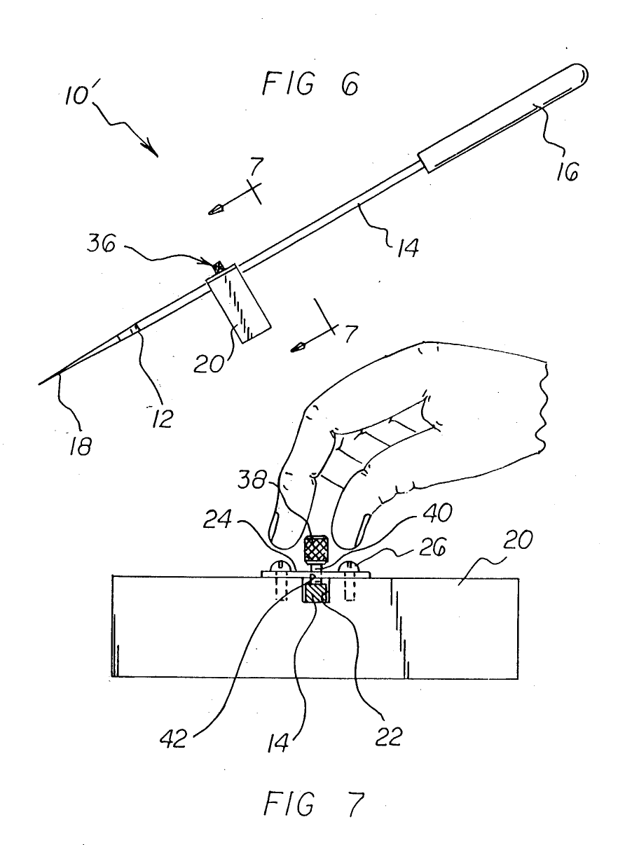

In some applications, it may be desirable to temporarily lock the leverage block or member 20 to the shaft portion 14 (i.e. temporarily affix the leverage block's relative axial position along the shaft). Turning now to FIGS. 6 and 7, there is shown an optional, alternatively preferred embodiment of the present invention further including a suitable locking means for manually and temporarily affixing the leverage block relative to and along the shaft of the apparatus. The preferred locking means, generally indicated by reference sign 36, comprises a conventional set screw having an enlarged knurled head portion 38 from which axially extends an externally threaded screw shaft portion 40 substantially as shown. The screw shaft portion 40 is suitably rotatably received in a complimentary screw threaded aperture 42 located in retainer plate 24 substantially centrally thereof so that the central axis of the screw threaded aperture (and that of the set screw) intercepts the shaft 14 substantially as depicted in FIG. 7.

By suitably manually rotating the set screw, the bottom end of the screw shaft portion may be brought into frictional engagement with the shaft portion 14 sufficient to securely affix the block 20 to the shaft portion 14 as will be appreciated by those of ordinary skill in the art. In this tightened down condition the leverage block 20 will remain stable relative to the shaft portion in a selected fulcrum position for repeated operations of the apparatus. When it is desired to achieve a new or different fulcrum position, the set screw or locking means 36 may easily be loosened, the leverage block moved or slid to its new selected position along shaft portion 14, and the set screw then manually re-tightened. Alternatively, the set screw may be left loosely captured in aperture 40 to achieve the same mode of operation as in the embodiment of FIGS. 1-5.

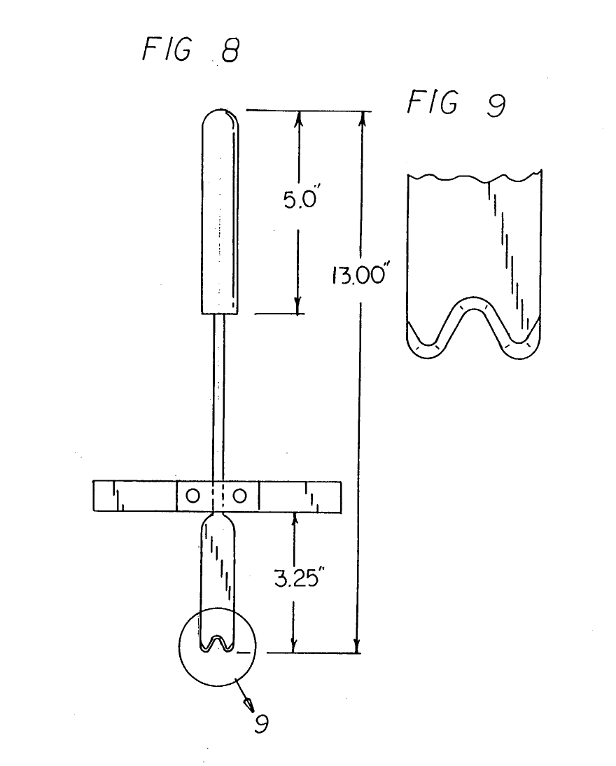

Turning now to FIGS. 8 and 9, there is shown a slightly modified form of the invention where the converging tine distal end shown in FIGS. 1-7 is replaced by a sharpened notched end edge substantially as shown. Without limitation, and merely for purposes of illustration, exemplary dimensions of the apparatus also are indicated in FIG. 8. With respect to the dimensions of block 20, it has been found suitable to size this part as follows: length=6 inches; width=1 2 inches; and thickness=¾ inches. It will be appreciated that the sharpened notched end edge of FIGS. 8 and 9 may be used in lieu of the converging tines of either embodiment of FIGS. 1-7.

The components of the weed digger apparatus of the invention can be made from inexpensive and durable metal, wood, and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved weed digger apparatus that is low in cost, relatively simple in design and operation, and which may advantageously be used to provide a manually operated implement that includes a fulcrum to provide for increased leverage and to assist in rotation of a weed being removed from the ground by the implement. With the invention, a weed digger apparatus provides a manually operated implement which has a ground-penetrating fork portion and a handle portion that are arrayed along a common longitudinal axis. With the invention, a weed digger apparatus provides a manually operated implement having variable leverage provided by a movable fulcrum. With the invention, optional locking means are provided for temporarily affixing the position of the movable fulcrum. With the invention, a weed digger apparatus is provided which includes a fork end that enables wedging of a weed between the tines of the fork. With the invention, a weed digger apparatus is provided which does not include a hinged fork and does not include a direction-reversing mechanism.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by Letters Patent of the United States is as follows:

1. A weed digger apparatus, comprising:
a fork portion,
a shaft portion connected to said fork portion,
a handle portion connected to said shaft portion,
a leverage block supported on said shaft portion and extending below said shaft portion, and
sliding block-to-shaft connection means for connecting said leverage block to said shaft portion.

2. The apparatus of claim 1 wherein said fork portion, said shaft portion, and said handle portion are arrayed along a common longitudinal axis.

3. The apparatus of claim 1 wherein said sliding block-to-shaft connection means include:
a shaft reception groove in said leverage block, wherein said shaft reception groove includes a groove width which is greater than a shaft width, and wherein said shaft reception groove includes a groove height which is greater than a shaft height,
a retention plate which covers said shaft reception groove, and
plate-to-block connector means for connecting said retention plate to said leverage block.

4. The apparatus of claim 3 wherein said plate-to-block connector means include plate retention fasteners.

5. The apparatus of claim 1 wherein said fork portion includes a pair of converging tines.

6. The apparatus of claim 1 wherein said fork portion comprises a sharpened notched distal end edge.

7. The apparatus of claim 1 wherein:
said shaft portion includes a polygonal shaft cross section,
said leverage block includes a shaft reception groove which includes a complementary polygonal groove cross section.

8. The apparatus of claim 7 wherein said polygonal shaft cross section and said complementary polygonal groove cross section are square cross sections.

9. The apparatus of claim 1 wherein said leverage block includes a leverage block length, a leverage block height, and a leverage block thickness.

10. The apparatus of claim 1 further including locking means associated with said sliding block-to-shaft connection means for selectably affixing the position of said leverage block relative to said shaft portion.

11. The apparatus of claim 10 wherein said locking means comprises a manually operable set screw affixed between said sliding block-to-shaft connection means and said shaft portion.
